(19) United States
(12) Patent Application Publication
(10) Pub. No.: US 2006/0173681 A1
(43) Pub. Date: Aug. 3, 2006

(54) Semi-covert emergency transmitter

(75) Inventors: F. Elliott Koch, Moorpark, CA (US); Patrick G. Maloney, Arlington, VA (US); Jon T. Ciemiewicz, Litchfield, NH (US)

Correspondence Address: MAINE & ASMUS, P. O. BOX 3445, NASHUA, NH, 03061, US

(73) Assignee: BAE SYSTEMS INFORMATION AND ELECTRONIC SYSTEMS INTEGRATION INC, Nashua, NH (US)

(21) Appl. No.: 11/047,935

(22) Filed: Feb. 1, 2005

(51) Int. Cl. G10L 17/00

(52) U.S. Cl. 704/246

(57) ABSTRACT

A semi-covert emergency transmission device and methodology for soldiers and other such personnel requiring pick-up or rescue is disclosed. The device has a flashlight mode and a transmit mode. In flashlight mode, an LED is turned on to provide an illumination source that can be used in numerous applications. In transmit mode, the device uses the same LED to transmit a coded message that includes information relevant to the user. The coded message can be preprogrammed and stored in the device, or translated in real-time. The transmit mode is further configured so as to confirm that the intended user is the one requesting the transmission of the coded message. The light emitted from the LED can be seen for up to a mile or so away by friendly forces or other potential rescuers.

### FIELD OF THE INVENTION

The invention relates to emergency transmitters, and more particularly, to a semi-covert emergency transmitter for soldiers and other such personnel requiring rescue.

### BACKGROUND OF THE INVENTION

In general, an emergency transmitter is a device that can be used by a person who, for what ever reason, requires assistance or rescue. The transmitter can be as simple as a conventional flash light or a more complex radio frequency (RF) transmitter. In any such cases, the transmitter can be used to signal the location of the person needing assistance.

The person could be, for instance, alone in their house or taking a walk, when they suddenly feel ill (e.g., from an ensuing heart attack or some other threatening condition). In such a case, the person could activate their personal emergency transmitter, which typically transmits or causes to be transmitted an RF signal that can be detected by a remote service organization that will then dispatch the appropriate personnel (e.g., such as medical personnel) to aid the ailing person.

The information transmitted by the emergency transmitter typically includes the location of the person at the time the signal is transmitted, so that the attending personnel know where to go. Numerous other such applications for emergency transmitters will be apparent, such as lost hikers, kidnap victims, lost children, trapped or stranded individuals, and any person needing assistance when there is no access to conventional channels of communication (e.g., telephones, cell phones).

Emergency transmitters are generally helpful in such situations, as they are relatively easy to activate (even for a child, or a distressed or ill person) and can function when other forms of communication such as telephones and cell phones are not functioning or are otherwise not an option for the person requiring assistance.

However, in cases where the person requiring assistance must be particularly covert in their signaling for help, conventional emergency transmitters are problematic. For example, consider the case where a soldier is trapped or imprisoned behind enemy lines. An RF transmission from that soldier would likely be intercepted, thereby compromising the soldier's emergency transmission as well as his position. In such a case, use of a flashlight as an emergency transmitter may be helpful and more covert than an RF transmission, but conventional flash lights tend to be bulky and are limited for purposes of communication.

In addition, conventional emergency transmitters are prone to use by enemy or otherwise unfriendly personnel. Thus, should such a transmitter fall into enemy hands, a false transmission can be sent, thereby luring rescuing personnel into a trap or an otherwise adverse situation.

What is needed, therefore, is a semi-covert emergency transmitter for soldiers and other such personnel requiring rescue.

### SUMMARY OF THE INVENTION

One embodiment of the present invention provides a semi-covert emergency transmitter device. The device includes a microphone for receiving verbal input, and converting that verbal input to an electrical signal. The verbal input can be, for instance, a key phrase required to initiate transmission of an emergency message, or a message for transmission. A verification module is adapted for verifying the verbal input was provided by an intended user. In one particular configuration, the verification module is implemented as voice recognition module adapted. A processor is adapted to provide a coded message in response to the verification module verifying the verbal input was spoken by the intended user. A light source is used for transmitting the coded message provided by the processor. The light source can be, for example, an light emitting diode (LED) or a laser. In one particular configuration, the processor has a transmit mode and a flashlight mode, with each mode being initiated by a user input requesting a particular mode. In the flashlight mode, the processor turns the LED on to provide an illumination source. The device may further include an analog to digital converter that is adapted to convert the electrical signal from the microphone into its digital equivalent, and to provide that digital signal to at least one of the processor and verification module. The device may further include a translation module that is adapted to convert the verbal input into a coded form that can be at least one of stored in a memory of the device and transmitted by the light source. The processor can be further adapted to provide the coded message only in response to the verbal input being spoken by the intended user a pre-defined number of times (e.g., where the verbal input is a key phrase that is spoken three times in a row to initiate transmission). The coded message can be stored in a memory accessible by the processor. Note that the verification module can be programmed or otherwise integrated into the processor.

Another embodiment of the present invention provides a method for semi-covert emergency transmission. The method includes receiving an electrical signal representative of a verbal input, and verifying the verbal input was provided by an intended user. In response to verifying the verbal input was spoken by the intended user, the method further includes transmitting a coded message using a light source (e.g., LED or miniature bulb or laser), thereby signaling a need for help in a semi-covert manner relative to radio frequency transmissions. The method may further include converting the verbal input into a coded form that can be at least one of stored in a memory of the device and transmitted by the light source. Verifying the verbal input was provided by an intended user may include, for example, at least one of performing voice recognition on the verbal input and ensuring the verbal input was spoken a pre-defined number of times.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIGS. 1a, 1b, and 1c show pictorial views of a semi-covert emergency transmitter configured in accordance with one embodiment of the present invention.

FIG. 2 shows a block diagram a semi-covert emergency transmitter circuit configured in accordance with one embodiment of the present invention.

FIG. 3 shows a method for carrying out a semi-covert emergency transmission in accordance with one embodiment of the present invention.

### DETAILED DESCRIPTION OF THE INVENTION

Embodiments of the present invention provide a semi-covert emergency transmission device and methodology for soldiers and other such personnel requiring pick-up or rescue. The device has a flashlight mode and a transmit mode. In flashlight mode, an LED is turned on to provide an illumination source that can be used in numerous applications. In transmit mode, the device uses the same LED to transmit a coded message that includes information relevant to the user.

For example, a soldier trapped behind enemy lines can use the device to transmit his name and other select personal information in Morse code (or some other established code) so that a nearby friendly aircraft or forces can detect the message and arrange for rescue of the soldier. The coded message can be preprogrammed and stored into the device, so that the soldier only needs to depress a transmit button to activate the transmission process.

In addition, the transmit mode is further configured so as to confirm that the intended soldier is the one requesting the transmission of the coded message. This confirmation can be carried out, for example, by requiring the soldier to recite a key phrase into a microphone of the device, and then performing voice recognition to ensure that the soldier is the one who recited the key phrase. Numerous security schemes can be used here, as will be apparent in light of this disclosure.

The light emitted from the LED can be seen for up to a mile or so away by friendly forces or other potential rescuers. At the same time, interception of the semi-covert emergency signal by unfriendly forces is less likely due to the localized nature of the light emitting from the LED, as compared to an RF emergency transmission. The device may further be configured with translation capability, so that messages spoken by the user are coded in real-time, to provide greater flexibility in the messages that can be transmitted.

Device Architecture

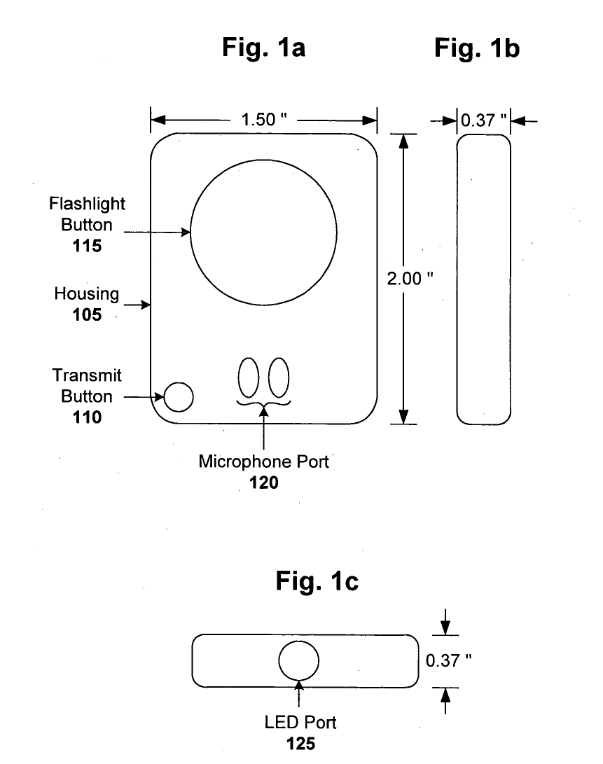

FIGS. 1a, 1b, and 1c show pictorial views of a semi-covert emergency transmitter configured in accordance with one embodiment of the present invention. As can be seen, the device includes a housing 105 configured with a transmit button 110, a flashlight button 115, a microphone port 120, and an LED port 125.

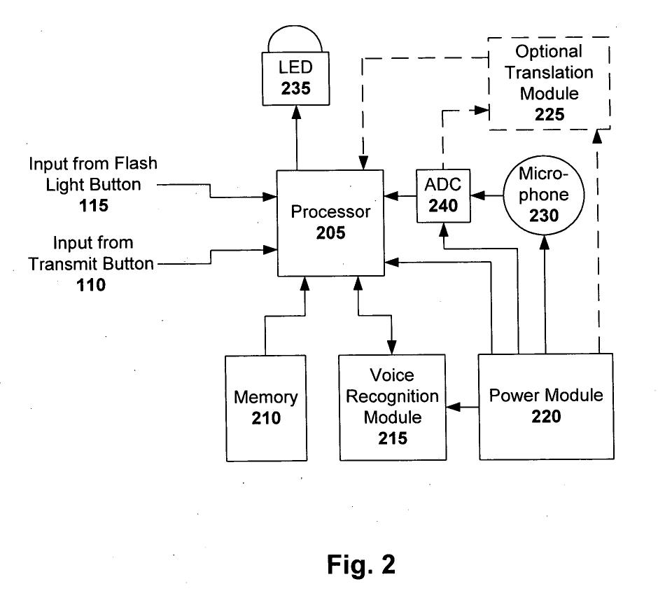

The housing 105 can be fabricated, for example, from injection molded plastic or machined aluminum or steel. The transmit button 110 and the flashlight button 115 can be implemented with, for instance, conventional push button switches. Each of the switches 110 and 115 can be covered with a supple rubber cover to protect the respective underlying switch. The microphone port 120 and the LED port 125 correspond to the position of microphone and LED components, respectively, within the housing 105. These internal circuit components, as well as other device circuitry, will be discussed in reference to FIG. 2.

This example housing embodiment is relatively compact compared to conventional transmission devices, measuring about two inches in length by one and half inches wide, and is under one half inch in thickness. Thus, the device could readily be stored in a pocket or pack of the user, or otherwise concealed on the user's person. Smaller or larger form factors can be realized here, and the present invention is not intended to be limited to any one such size or configuration.

FIG. 2 shows a block diagram a semi-covert emergency transmitter circuit configured in accordance with one embodiment of the present invention. The circuit includes a processor 205, a memory 210, a voice recognition module 215, a power module 220, a microphone 230, an LED 235, and an analog to digital converter (ADC) 240. An optional translation module 225 can also be provided. Each of the components can be mounted on a printed wire circuit board, with conductor runs interconnecting the components as necessary, as is conventionally done.

The processor 205 can be implemented with conventional technology, such as a field programmable gate array (FPGA), application specific integrated circuit (ASIC), or a microcontroller, and is programmed or otherwise configured to coordinate the overall function of the device as discussed herein. The processor 205 operates in two modes: flashlight mode and transmit mode.

In operation, the processor 205 enters the flashlight mode when it receives input from the flashlight button 115. For instance, when the flashlight button 115 switches from its off state to its on state, the processor 205 responds by switching power to the LED 235, thereby turning the LED 235 on. In this example configuration, the power that is switched to the LED 235 by the processor 205 is provided by power module 220, which can be a battery or other conventional power source. The LED 235 will remain on until the flashlight button 115 switches to its off state, or until the processor enters the transmit mode.

The processor 205 enters the transmit mode when it receives input from the transmit button 110. For instance, when the transmit button 110 switches from its off state to its on state, the processor 205 responds by waiting for the user to speak a key phrase into the microphone 230. The key phrase can be any pre-established word or group of words. The microphone 230 converts the spoken key phrase into an analog signal, and ADC 240 converts that signal to its digital equivalent (e.g., with 8 to 32 bit resolution, depending on desired conversion accuracy). The digital signal is then provided to the processor 205 for analysis.

In this embodiment, the processor 205 passes the digital signal to the voice recognition module 215, which can be implemented with conventional technology, such as that used in cell phone applications configured with voice recognition. The voice recognition module 215 then determines if the spoken key phrase was actually spoken by the intended user of the device. For example, the voice recognition module 215 can be configured to digitally compare a previously recorded sample of the intended user's voice with the spoken key phrase. The previously recorded sample can be, for instance, the key phrase or a series of words and sounds sufficient to provide the module 215 with a baseline to perform the comparison.

Note that either the processor 205 or the voice recognition module 215 can also be programmed or otherwise configured to require the key phrase to be spoken a pre-defined number of times (e.g., three times) before proceeding with the transmit process. Other confirmation and security schemes can be used here as well, such as entry of a multi-digit code using a keypad (not shown), or requiring a specific number of finger taps at the microphone port 120, properly spaced in time (e.g., according to a melody or other established cadence).

Once the request for transmit mode is verified as legitimate, the processor 205 then retrieves emergency transmit information from the memory 210. In one embodiment, this emergency transmit information includes the user's name, social security number, and mother's maiden name, and is stored in a coded form, such as in Morse code or some other established code that can be transmitted using LED 235. In general, the emergency transmit information can be any message that can communicates or is otherwise established as a signal for assistance.

The processor 205 then provides that coded emergency transmit information to the LED, thereby causing the LED 235 to flash on and off in accordance with the coded emergency transmit information. The processor 205 can be further configured to transmit the coded message a number of times (e.g., twice) before exiting the transmit mode, with a small delay (e.g., 10 seconds) between each transmission. After transmission is complete, the device can go into a dormant mode, or can go back into flashlight mode (assuming it was in flashlight mode prior to the transmission).

The device can also be configured with the optional translation module 225, which would allow messages spoken into the microphone to be translated into code. In one particular embodiment, the optional translation module 225 is programmed or otherwise configured to convert digital equivalents of the spoken messages captured by microphone 230 into Morse code or any other established code that can be communicated by LED 235. The optional translation module 225 could be configured, for example, with a digital library of previously spoken common words known to the user, with each of the stored words associated with its coded equivalent. Thus, when the user speaks any combination of those stored words, the translation module 225 can digitally compare each word received (e.g., in digital format from ADC 240) with the library of words to identify the corresponding codes. The set of words in the library can be set as desired. The coded messages can then be provided to the processor 205 for transmission via the LED 235, or for storage in memory 210.

Note that the example configuration shown in FIG. 2 has various functionality in separate modules. Other configurations are possible here, where one or more of the modules (or their functionality) are integrated with other modules. For example, assume that processor 205 is implemented with a microcontroller unit (MCU) configured with a processor, memory, a number of I/O ports, and programmable functionality. Here, memory 210 could be included in the MCU. Also, each of the voice recognition module 215 and the optional translation module 225 could be implemented as a process (e.g., set of executable instructions) running on the processor of the MCU. Other suitable processing environments will be apparent in light of this disclosure.

Other processes and functionality may also be included in the processor 205, such as the ADC 240 for receiving analog input from the microphone 230, and converting that input to its digital equivalent.

Also, a third button could be provided on the housing 105, such as a program button that could be pressed and held during programming of the device. In one such case, the processor 205 would receive the programming signal from the programming button, thereby causing the processor 205 to wait for digitized verbal input from the microphone 230 and ADC 240. Such a feature would allow a user to, for example, program the key phrase or an emergency transmit message, or to stock the voice recognition module 215 with sample voice data. Once the programming button was released, the processor 205 would go back to its dormant mode and wait for user input. Note that the initial programming of the device can be carried out without taking security measures, but subsequent re-programming can be protected by a security scheme, where certain tests (e.g., key phrase and voice recognition) must be passed before the re-programming is allowed.

Also, a power conservation routine can be programmed into processor 205, where the device stays in a low power sleep mode until input from a user is received, thereby extending the life of power module 220. For example, only the processor would be provided with power from the power module 220 during sleep mode. If user input is received by the processor 205, then the power conservation routine running therein can be configured to connect power to only portions of the circuit that are required to carry out the requested functionality. For instance, if flashlight mode is requested, power from module 220 is provided to the processor 205 and LED 235 only. If transmit mode is requested, then processor 205, voice recognition module 215, microphone 230, ADC 240, and optional translation module 235 (if included) would be powered until user verification was completed, and then only the processor 205 and LED 235 would be powered while the transmission was carried out (assuming verification passed). Numerous power conservation schemes can be used here.

Methodology

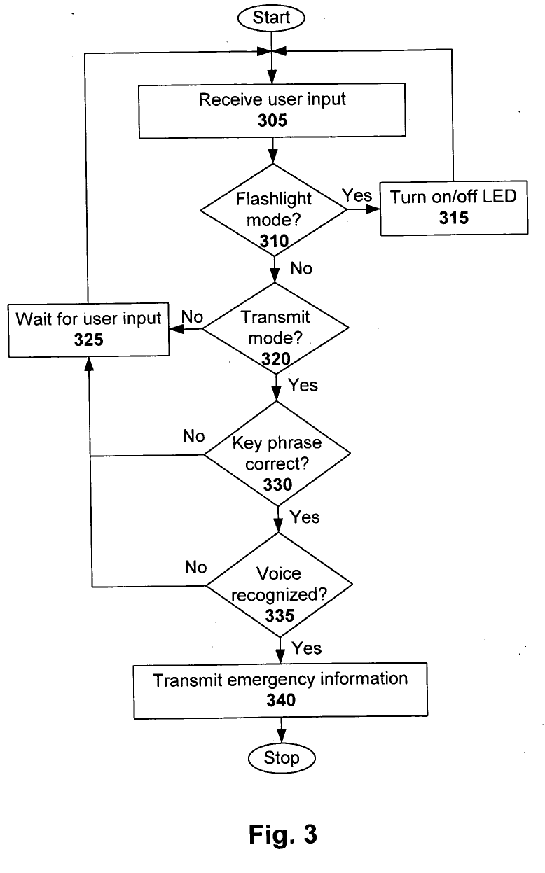

FIG. 3 shows a method for carrying out a semi-covert emergency transmission in accordance with one embodiment of the present invention. The method can be carried out or otherwise directed, for instance, by the processor 205 of the semi-covert emergency transmission device shown in FIG. 2.

The method begins with receiving 305 user input (e.g., via the flashlight button or the transmit button). The method continues with determining 310 if the flashlight mode is being requested or deactivated. If so, then the method continues with turning 315 an LED (or other suitable light source that can be used to notify friendly forces) on or off. If the flashlight mode is not being requested or deactivated, then the method continues with determining 320 if the transmit mode is being requested. If not, then the method continues with waiting 325 for valid user input.

If the transmit mode is being requested, then the method continues with determining 330 if a key phrase spoken into the device is correct (e.g., where the user is required to say “red” three times into the microphone 230). If not, then the method continues with waiting 325 for valid user input. If the key phrase spoken into the device is correct, then the method continues with determining 335 if the voice that spoke the key phrase is recognized (e.g., using conventional voice recognition technology). Note that the method may further include converting the spoken key phrase into digital format to facilitate its processing in steps 330 and 335.

If the voice that spoke the key phrase is not recognized, then the method continues with waiting 325 for valid user input. If the voice that spoke the key phrase is recognized, then the method continues with transmitting 340 emergency information (e.g., using LED 235). Note that the method may further include retrieving the emergency information from a memory (e.g., memory 210) where it is stored in a coded format that is capable of transmission by the LED. This transmitting can be repeated a number of times, as desired. The transmission may also be cancelled if so desired (e.g., by pressing the transmit button again).

Variations on the method will be apparent in light of this disclosure. For instance, if the flashlight mode was enabled prior to the occurrence of waiting 325 for user input, then it can be configured to remain enabled (so that the flashlight stays on if a failed request for transmission occurs).

Also, the method may further include an anti-tamper feature, where if the transmit mode is entered and the key phrase and/or voice recognition tests fail more than a pre-defined number of times, then the device can be configured to shut down or take some other defensive action. Also, the method may further include a programming mode that allows a user to program or re-program the device.

Also, note that light sources other than an LED can be used to communicate a discreet message. For instance, the light source could be miniature light bulb. Alternatively, the light source could be a laser, such as those used in a laser pointer. In such an application, the laser could be visible laser light that could be seen or otherwise detected by potential rescuers. Alternatively, the laser light could be on the invisible end of the spectrum, and could be used in conjunction with detectors designed to detect the transmitted emergency laser information. The detectors could be deployed on the bottom of friendly aircraft or on the ground at strategic locations proximate the user's field of operation.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A semi-covert emergency transmitter device, comprising:
a microphone for receiving verbal input, and converting that verbal input to an electrical signal;
a voice recognition module adapted for verifying the verbal input was spoken by an intended user;
a processor adapted to provide a coded message in response to the voice recognition module verifying the verbal input was spoken by the intended user; and
an light emitting diode (LED) for transmitting the coded message provided by the processor.

2. The device of claim 1 further comprising:
an analog to digital converter adapted to convert the electrical signal from the microphone into its digital equivalent and to provide that digital signal to at least one of the processor and voice recognition module.

3. The device of claim 1 further comprising:
a translation module adapted to convert the verbal input into a coded form that can be at least one of stored in a memory of the device and transmitted by the LED.

4. The device of claim 1 wherein the processor is further adapted to provide the coded message only in response to the verbal input being spoken by the intended user a pre-defined number of times.

5. The device of claim 1 wherein the processor has a transmit mode and a flashlight mode, with each mode being initiated by a user input requesting a particular mode.

6. The device of claim 5 wherein in the flashlight mode, the processor turns the LED on to provide an illumination source.

7. The device of claim 1 wherein the coded message is stored in a memory accessible by the processor.

8. The device of claim 1 wherein the voice recognition module is integrated into the processor.

9. A semi-covert emergency transmitter device, comprising:
a microphone for receiving verbal input, and converting that verbal input to an electrical signal;
a verification module adapted for verifying the verbal input was provided by an intended user;
a processor adapted to provide a coded message in response to the verification module verifying the verbal input was spoken by the intended user; and
a light source for transmitting the coded message provided by the processor.

10. The device of claim 9 further comprising:
an analog to digital converter adapted to convert the electrical signal from the microphone into its digital equivalent and to provide that digital signal to at least one of the processor and verification module.

11. The device of claim 9 further comprising:
a translation module adapted to convert the verbal input into a coded form that can be at least one of stored in a memory of the device and transmitted by the light source.

12. The device of claim 9 wherein the processor is further adapted to provide the coded message only in response to the verbal input being spoken by the intended user a pre-defined number of times.

13. The device of claim 9 wherein the processor has a transmit mode and a flashlight mode, with each mode being initiated by a user input requesting a particular mode.

14. The device of claim 13 wherein the light source is an light emitting diode (LED).

15. The device of claim 9 wherein the coded message is stored in a memory accessible by the processor.

16. The device of claim 9 wherein the verification module is integrated into the processor.

17. A method for semi-covert emergency transmission, comprising:
receiving an electrical signal representative of a verbal input;
verifying the verbal input was provided by an intended user; and
in response to verifying the verbal input was spoken by the intended user, transmitting a coded message using a light source, thereby signaling a need for help in a semi-covert manner relative to radio frequency transmissions.

18. The method of claim 17 further comprising:
converting the verbal input into a coded form that can be at least one of stored in a memory of the device and transmitted by the light source.

19. The method of claim 17 wherein verifying the verbal input was provided by an intended user includes performing voice recognition on the verbal input.

20. The method of claim 17 wherein verifying the verbal input was provided by an intended user includes ensuring the verbal input was spoken a pre-defined number of times.
